(19) United States
(12) Patent Application Publication
(10) Pub. No.: US 2003/0131097 A1
(43) Pub. Date: Jul. 10, 2003

(54) Interactive path analysis

(76) Inventors: Stephane Kasriel, San Francisco, CA (US); Sara Swanson, Los Gatos, CA (US)

Correspondence Address: ROBERT M. MCDERMOTT, ESQ., 1824 FEDERAL FARM ROAD, MONTROSS, VA, 22520, US

(21) Appl. No.: 10/128,598

(22) Filed: Apr. 22, 2002

Related U.S. Application Data
(60) Provisional application No. 60/347,389, filed on Jan. 9, 2002.

(51) Int. Cl. G06F 15/173

(52) U.S. Cl. 709/224

(57) ABSTRACT

A user interface allows a user to select a particular web-page, and a display processor presents transversal links relative to this selected web-page, indicating the web-pages from-which visitors have come to this web-page, and the web-pages to-which visitors go to when leaving this web-page. Preferably, the presentation of the transversal links is in graphic form. A directed graph is presented that illustrates path information as annotated links between nodes of the graph. Each node in this presentation represents a web-address and each link represents traversals between two of the nodes. The user is provided interactive options that include changing the names of the nodes to more meaningful alias, grouping of nodes to obtain higher-level views of the path patterns, redefining the form and format of the annotations, and so on. Presenting the path-analysis information in a graphical form provides the user with a more immediate and intuitive understanding of the flow of visits to and through a user's web-site.

This application claims the benefit of U.S. Provisional Application No. 60/347,389, filed Jan. 9, 2002, Attorney Docket FC011022B.

### BACKGROUND OF THE INVENTION

1. Field of the Invention

This invention relates to the field of computer networks, and in particular to a system and method that facilitates an analysis of traffic patterns within and between sites on a network.

2. Description of Related Art

Traffic analysis is a necessary tool for effective web-site management and on-going website development, as well as for the development of effective marketing strategies. Web-site managers, hereinafter webmasters, desire information that can be used to enhance the web-site's performance or appearance. Electronic-commerce marketing managers, hereinafter marketers, desire information that can be used to enhance the sales resulting from visits to a web-site, to enhance advertising revenue from the web-site, and/or to determine the effectiveness of advertising expenses to other web-site providers.

Tools are commonly available for collecting traffic data. A fundamental tool, for example, collects data regarding the number of times each page at a web site is accessed within a given period of time (e.g. ‘hit-rate’ statistics). A more sophisticated tool, such as the Netflame™ product from Fireclick, Inc., collects data regarding entries to and exits from each page at a web site. By tracking visitors' paths through the website, a Netflame™-enabled web-site can be configured to anticipate a next-page that a visitor is likely to visit, and can initiate a download of some or all of the anticipated next-page while the visitor is viewing the current page. In this manner, the performance of the web-site is significantly enhanced, because, from the visitor's perspective, the anticipated next-page appears to download instantaneously. Only if the visitor chooses an unanticipated next-page will the visitor experience the true download delay duration.

Copending U.S. patent application “PREDICTIVE PRE-DOWNLOAD USING NORMALIZED NETWORK OBJECT IDENTIFIERS”, Ser. No. 09/734,910, filed Dec. 11, 2000 for Stephane Kasriel, Xavier Casanova, and Walter Mann, discloses a preferred technique for determining and downloading the anticipated next-page, and is incorporated by reference herein. Of particular note, this copending application also discloses the concept of a “normalized” web-page, wherein alternative versions of a web-page are analyzed and processed as a single web-page. That is, alternative versions of a web-page may include an element that varies, depending upon the environment, the particular viewer, the class of viewer, a currently advertised special, and so on. Each version may potentially correspond to a different web-page, because each version may have a different URL (Uniform Resource Locator). If processed and analyzed separately, the individual statistics that are associated with each of the different versions of a web-page would generally be meaningless. A normalized web-page comprises all of the non-varying elements of the alternative versions, and the data collected corresponding to each of the alternative versions is associated with the normalized web-page. In this manner, statistics are provided for the web-page, independent of variables associated with the web-page. For ease of reference and understanding, the term web-page as used herein includes a normalized web-page, and other collections of pages, files, and data that form a cohesive entity for traffic-analysis reporting purposes. For example, copending U.S. patent application “PREDICTIVE PREDOWNLOAD OF TEMPLATES WITH DELTA ENCODING, Ser. No. 10/079,932, filed Feb. 19, 2002 for Stephane Kasriel, incorporated by reference herein, discloses the use of “templates” that correspond to the relatively unchanging portions of a web-page, and “deltaencoding” to encode the portions of a web-page that change. As defined herein, the templates with multiple and varied delta-encodings correspond to a web-page. Other examples of collections of material forming a cohesive entity for traffic-analysis will be evident to one of ordinary skill in the art.

A marketable traffic-analysis product must include one or more tools for providing reports that are based on the collected traffic-pattern data. Generally, traffic analysis tools provide pre-defined reports, or allow a user to create custom reports, or both. The typical reporting tools are conventional data-processing tools that provide tables of statistics, graphs of trends over time, and so on. Because the potential users of the traffic data may include IT-executives, webmasters, e-marketers, development engineers, and so on, it is difficult to develop a standard set of reports that encompass the needs of all potential users. To allow for customized reports, a data-base-management system may be provided to allow the development of such reports by or for each potential user, but such an approach requires an investment of time and resources to develop such reports. And, while such data-analysis reports may contain a significant amount of information, the typical presentation of the information in a tabular form does not necessarily facilitate a meaningful interpretation of the data.

### BRIEF SUMMARY OF THE INVENTION

It is an object of this invention to present traffic-analysis and/or path-analysis data in an easy to interpret form. It is a further object of this invention to allow a user to modify the presentation of traffic-analysis and path-analysis data.

These objects, and others, are achieved by providing a method and system for presenting path-analysis data in an easy-to-use form. A user interface allows a user to select a particular web-page, and a display processor presents the transversal links relative to this selected web-page. Preferably, the presentation of the transversal links is in graphic form. A directed graph is presented that illustrates path information as annotated links between nodes of the graph. Each node in this presentation represents a web-address and each link represents traversals between two of the nodes. The traversals include a traversal from a first web-address to a second web-address, as well as traversals going from the second web-address to the first web-address. The user is provided options that include changing the names of the nodes to more meaningful alias, grouping of nodes to obtain higher-level views of the path patterns, redefining the form and format of the annotations, and so on. Presenting the path-analysis information in a graphical form provides the user with a more immediate and intuitive understanding of the flow of visits to and through a user's web-site.

### BRIEF DESCRIPTION OF THE DRAWINGS

The invention is explained in further detail, and by way of example, with reference to the accompanying drawings wherein:

FIG. 1 illustrates an example block diagram of a path analysis system in an Internet environment in accordance with this invention.

FIG. 2 illustrates an example graphic display of path analysis information in accordance with this invention.

FIG. 3 illustrates an example graphic display of path analysis information after a user selection of a target page in accordance with this invention.

FIG. 4 illustrates another example graphic display of path analysis information after other user modifications in accordance with this invention.

Throughout the drawings, the same reference numerals indicate similar or corresponding features or functions.

### DETAILED DESCRIPTION OF THE INVENTION

This invention is presented herein using the paradigm of a path-analysis system having the capabilities of the aforementioned Netflame™ product from Fireclick, Inc. As will be evident to one of ordinary skill in the art, the principles of this invention are applicable to other traffic-analysis and path-analysis systems and products.

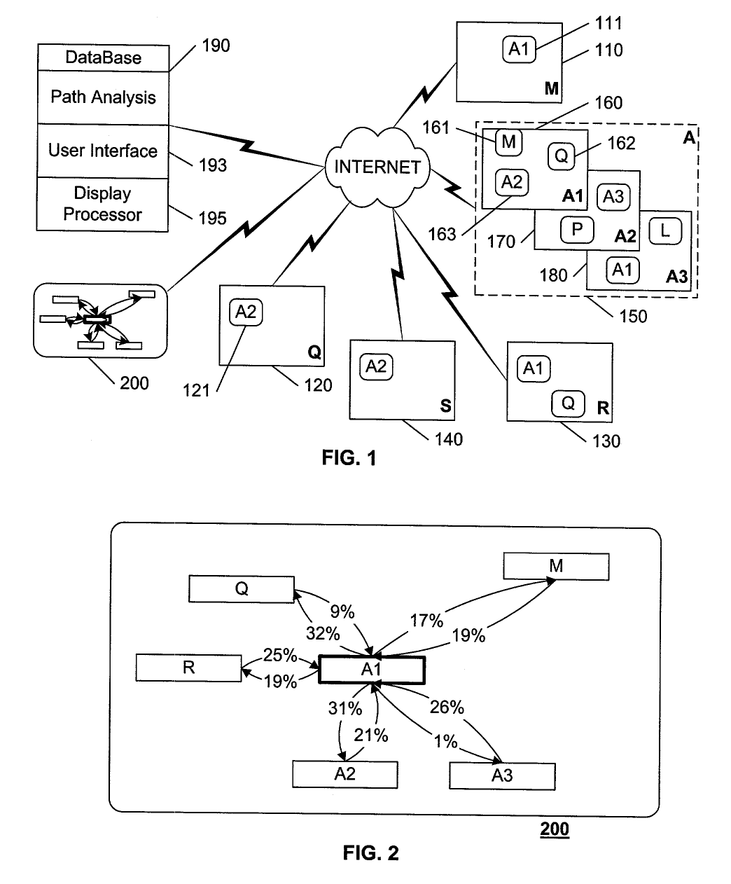

FIG. 1 illustrates an example block diagram of a path analysis system in an Internet environment in accordance with this invention. A number of web-sites M 110, Q 120, R 130, S 140, and A 150 are illustrated as being a part of the Internet network. Web-site A 150 is illustrated as containing three web-pages 160, 170, 180, whereas, for ease of understanding web-sites M 110, Q 120, R 130, and S 140 are illustrated as single web-pages.

Each of the web-pages 110-180 is illustrated as containing one or more “buttons” for traversing to another web-page. Web-page M 110, for example, contains a button 111 that effects a traversal to web-page A1 160. Web-page Q 120 contains a button 121 that effects a traversal to web-page A2 170. Web-page A1 160 contains buttons 161, 162, 163 that effect a traversal to web-pages M 110, Q 120, and A2 170, respectively. Not illustrated, conventional web-browsers include “back” and “forward” buttons for traversing to prior accessed web-pages.

Also illustrated in FIG. 1 is a path-analysis block 190 that is configured to detect and record traversals to and from select web-sites. In the aforementioned Netflame™ product, a subscriber to the path-analysis program adds a line of program code to each web-page. This line of program code effects a recording of an identification of an incoming or outgoing web-page upon each entry and exit to and from the web-page. Any of a variety of techniques, common in the art, can be employed to record and collect this information. Generally, one or more processes are used to record the information in a database, and another process is used to retrieve the information. For the purposes of this disclosure, a database is any collection of data that facilitates efficient retrieval of the data, and may include a distribution of data storage entities. For example, a collection of counters that are configured to count the number of traversals to and from specific web-pages constitute a database, because the retrieval process need only access these counters to retrieve the traversal data. The database may contain only data that provides frequency distribution information, or it may contain additional information, such as other parameters related to each traversal to and from the site, such as the time-of-day, an identification of the visitor, and so on. In this example, web-site A 150 is the select web-site. The path-analysis block 190 accesses the traversals database to provide statistics related to traversals to and from each web-page A1-A3 160-180 of the subscribing web-site A 150.

In accordance with this invention, the path-analysis block 190 includes a user interface 193 that allows a user to select a particular web-page as the ‘target’ or ‘focus’ web-page, and display processor 195 that presents a display 200 of traversal links relative to the target web-page. As will be evident to one of ordinary skill in the art, the user interface 193 and display processor 195 need not be contained within the path-analysis block 190; this particular architecture is illustrated for ease of understanding. That is, for example, the user interface 193 and/or the display processor 195 may be located at each user's computer, and configured to access the path-analysis block 190 as required to obtain the desired path-analysis information.

By allowing a user to select a web-page of interest and customizing the presentation of the path-analysis information relative to this web-page, the presentation is likely to be more meaningful than a conventional data-base report that displays all of information at an equal level of prominence. In a preferred embodiment of this invention, the path-analysis information is presented in graphic form, thereby further enhancing the intuitive understanding of the presented information.

FIG. 2 illustrates an example graphic display 200 of path analysis information in accordance with this invention. In this example, the web-pages and the traversals between the web-pages are illustrated as nodes and links, respectively, in a directed graph.

In the example display 200, web-page A1 has been identified as the target, and all of the traversals to and from web-page A1 are illustrated. The percentages associated with each link represent the percentage of traversals to and from A1, relative to node A1. For example, the link from node R to A1 indicates 25%. This figure indicates that 25% of the traversals to A1 arrive from node R. In like manner, 9% of the traversals to A1 are from Q, 19% from M, 21% from A2, and 26% from A3, thereby accounting for 100% of the traversals to A1. Regarding traversals from node A1, 19% are to R, 32% to Q, 17% to M, 31% to A2, and 1% to node A3.

This graphic presentation presents useful information to a marketer or a Webmaster. Note, for example, that although 25% of the traversals to node A1 are from node R, 19% of the traversals are back to node R. As illustrated in FIG. 1, the example web-page A 160 does not have a button for linking to node R. Therefore, the 19% of the traversals from A1 to R must have been in response to a visitor hitting the “back” button on the visitor's browser. Typically, a user hits the back button when the visitor discovers that the content of the selected page was not what the visitor was looking for, or when the visitor loses patience with an excessive download delay or other web-page anomaly. From a marketing viewpoint, the presentation of A1 at web-page R is apparently very effective for bringing visitors to A1 from R, but most of these visitors are apparently disappointed when they arrive at A1. Other insights can be gained from this presentation, as will be evident to one of skill in the art of e-commerce. For example, if the intent of web-page A1 is to present an overview of a product, with subsequent transactions at page A2, then A3, web-page A1 appears to be somewhat effective, in that almost a third of the visitors do traverse to the next-page A2.

Note that the display 200 of FIG. 2 presents all of the web-pages within one traversal of the target, A1. As would be evident to one of ordinary skill in the art, the display could easily be modified to show all nodes within two, or three, or N traversals of the target. In a preferred embodiment, the user is provided the option of selecting the ‘depth’ of the graph relative to the selected node. Obviously, the ‘depth’ of the graph and the contents of the graph within a given depth will be dependent upon the information collected by the path-analysis program. Generally, the increased depth will only include additional nodes within the user's web-site, because the path-analysis information is limited to a depth of one for external sites. In another preferred embodiment, the user is provided the option of displaying traversals between non-select nodes on the graph. For example, in FIG. 2, the display 200 can be configured to also display the traversals between Q and A2, and/or between A2 and A3, etc. even though these nodes are not the select-node. In such a presentation, a convention is established regarding the interpretation of the percentages presented for links that are not associated with the select-node. For example, the percentage for each outgoing link that is not associated with the select-node may be defined as the percentage of traversal from the particular node. Alternatively, the percentages may be defined for each incoming link that is not associated with the select-node relative to the traversals to the particular node. As will be evident to one of ordinary skill in the art in view of this disclosure, any of a number of other conventions and display options may be used to convey statistics relative to each link, provided that the definition of the presented parameters are provided to the user.

In accordance with one aspect of this invention, the user is provided the option of selecting another node on the graph as the target, and the display processor presents another display of traversals, relative to this target. In a preferred embodiment, the user merely ‘clicks’ on the node corresponding to the select web-page to identify it as the new target.

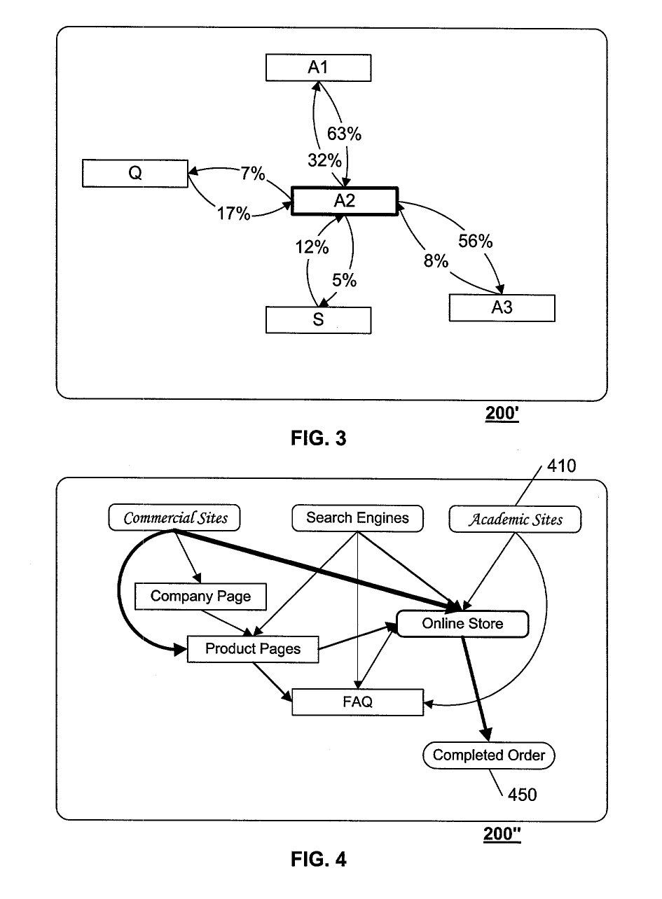

FIG. 3 illustrates an example display 200′ corresponding to a user's selection of node A2 as the target. This display 200′ provides additional marketing and web-development insights. If, as noted above, web-pages A1, A2, A3 are intended to lead a visitor through a sequential process (e.g. A1:“view”, A2:“select”, A3:“purchase”), then A2 in this example would appear to be fairly effective, in that more than half (56%) of the visitors proceed to the A3 (“purchase”) page.

Although the displays 200 and 200′ are illustrated as independent graphs, in a preferred embodiment of this invention, the user is provided the option of creating a graph for a newly selected target that include the nodes and links of previously generated graphs.

In accordance with another aspect of this invention, the user is also provided the option of customizing the displayed output. The user is provided the option of assigning “alias” names to each of the nodes, to display a more intuitively meaningful display. The user is also provided the option of changing the size, shape, color, and other visible features of the nodes and links in the graph. In like manner, the user is provided the option of not displaying links having traversal rates below a threshold value, of displaying only outgoing traversals, or only incoming traversals, and so on. In a preferred embodiment of this invention, the user is provided the option of saving the customized displays as ‘templates’, for subsequent use. Library facilities are also provided for efficient retrieval and/or distribution among multiple users. Depending upon the particular configuration, these templates may be stored at each user's workstation, or stored at a server that is configured to provide the user interface and display processing.

FIG. 4 illustrates an example display 200″ wherein each node is given an identifying alias, and wherein the percentages associated with each link are indicated by the thickness of the lines used to draw the link. Different shapes are used to distinguish nodes, as well as different fonts. FIG. 4 also illustrates some of the above features noted above. For example, the “Completed Order” node 450 is configured to only incoming traversals, because, generally, there is little interest in traversals after a sale is made. In addition, a general threshold filter has been applied, wherein only traversal percentages above a specified threshold amount are displayed, as evidenced by the relative paucity of traversal links. As can be seen, by providing a user with interactive options for modifying the presentation of the path-analysis information, an easy-to-comprehend result can be easily obtained.

Any of a variety of techniques can be provided to allow a user to develop a visually meaningful display, including the use of color and shading to highlight or de-emphasize certain nodes or links. In a preferred embodiment, for example, the user is provided the option of defining a range of expected traversal percentages for select nodes, and the display processor is configured to display links that lie outside their expected range to be highlighted in red (or other user selectable color).

In accordance with another aspect of this invention, the user is also provided the option of defining sets of web-pages that form single nodes for selection, display, or analysis purposes, and different visual characteristics, such as color, font, etc. can be used to easily identify and distinguish these nodes. In the example of FIG. 4, each composite node corresponding to a set of nodes is illustrated as a rectangle with slightly rounded corners, although not all composite nodes need have the same display characteristics. As illustrated in FIG. 4, the user provides a name (“Academic Sites”, “Commercial Sites”, etc.) for each defined set of nodes, and may also define fonts, styles, colors, and so on, as described above relative to single-page nodes. For example, a node “Academic Sites” 410 is illustrated. This may correspond, for example, to a user having defined all web-pages from sites having an “.edu” suffix as the set of pages corresponding to the “Academic Sites” set of web-pages. The display processor is configured to pre-process the path-analysis information to form a composite statistic corresponding to this set. For example, if a defined set includes the nodes Q and S of FIG. 3, the display processor will present a single node having a 29% traversal rate into node A2, and a 12% traversal rate from node A2. In this manner, the user can consolidate information that might be difficult to assimilate when presented as individual traversal nodes. Note that the groupings into sets may be for display purposes only, such that the individual nodes of the set are presented as individually displayed nodes, but, as part of the set, each node shares one or more display characteristics, such as color, shape, size, and so on.

The user is similarly provided the option to name individual links, to group sets of links together, to define display characteristics relative to the individual links or sets of links, and so on. In this manner, for example, a user may distinguish between “within-site” links and “external” links, and may have each set represented by a different color. In like manner, the aforementioned link display-thresholding process, for example, can be configured to allow different thresholds for different sets of links.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the particular statistic(s) associated with the traversal links may differ from a traversal percentage. In a basic embodiment of this invention, there may be no statistic associated with the links, the display merely being an identification of the nodes within a given traversal depth of the target. In a more sophisticated embodiment of this invention, the statistic may be based on parameters in addition to the frequency distribution of the traversals, depending upon the information available from the path-analysis element or other tools. For example, data may be collected over a period of time to define “normal” traversal patterns, and the display may be configured to display variances from this norm, using conventional statistical techniques to identify variances that significantly differ from the norm. Note also that the example displays are provided for illustrative purposes. One of ordinary skill in the art will recognize various alternative display strategies in view of this disclosure. For example, the display processor may be configured to present all pages of a web-site, regardless of whether each web-site has been traversed to or from the target. Generally, this entire-web-site display is provided as a common format, with the links added as particular nodes are selected as targets. In this manner, nodes that provide or receive no traversals become readily apparent as isolated islands that need to be addressed. These and other system configuration and optimization features will be evident to one of ordinary skill in the art in view of this disclosure, and are included within the scope of the following claims.

We claim:

1. A system comprising:
a user interface that is configured to allow a user to identify a select target,
a display processor, operably coupled to the user interface, that is configured to provide a display of traversals relative to the select target,
wherein
the traversals include at least one of:
incoming links that identify locations from which prior users arrived at the select target, and
outgoing links that identify locations to which the prior users departed from the select target.

2. The system of claim 1, wherein
the user interface is further configured to allow the user to subsequently select one of the identified locations as the select target.

3. The system of claim 1, wherein
the select target includes a page of an Internet web site.

4. The system of claim 1, wherein
the display of the traversals relative to the select target is presented as a directed graph.

5. The system of claim 4, wherein
links of the directed graph are displayed based on a frequency distribution associated with occurrences of the prior users arriving at and departing from the select target.

6. The system of claim 1, further including
a database access device that is configured to access a database that contains a frequency distribution associated with occurrences of the prior users arriving at and departing from the select target, via the incoming and outgoing links, and
wherein
the display processor is further configured to display the traversals based on the frequency distribution.

7. The system of claim 1, further including
the database.

8. The system of claim 1, further including
a path-analysis element that is configured to record at least one of:
the locations from which prior users arrived at the select target, and
the locations to which the prior users departed from the select target.

9. The system of claim 8, wherein
the path-analysis element is further configured to record data corresponding to a frequency distribution of traversals relative to the select target.

10. A method of presenting path-analysis information, comprising:
allowing a user to identify a select target,
displaying traversals relative to the select target,
wherein
the traversals include at least one of:
incoming links that identify locations from which prior users arrived at the select target, and
outgoing links that identify locations to which the prior users departed from the select target.

11. The method of claim 10, further including:
allowing the user to subsequently select one of the identified locations as the select target, and
displaying traversals relative to the select one of the identified locations.

12. The method of claim 10, wherein
the select target includes a page of an Internet web site.

13. The method of claim 10, wherein
displaying the traversals relative to the select target includes displaying a directed graph.

14. The method of claim 13, wherein
links of the directed graph are displayed based on a frequency distribution associated with occurrences of the prior users arriving at and departing from the select target.

15. The method of claim 10, further including
accessing a database that contains a frequency distribution associated with occurrences of the prior users arriving at and departing from the select target, via the incoming and outgoing links, and
displaying the traversals based on the frequency distribution.

16. The method of claim 10, further including
recording at least one of:
the locations from which prior users arrived at the select target, and
the locations to which the prior users departed from the select target.

17. The method of claim 16, further including
recording data corresponding to a frequency distribution of traversals relative to the select target.

18. A system comprising:
a path analysis tool that is configured to provide a graph of a plurality of nodes and traversal links associated with each node of the plurality of nodes, and
a user interface, operably coupled to the path analysis tool, that is configured to allow a user to define a mapping corresponding to at least one of:
a node name to a node of the plurality of nodes,
a common node-display characteristic to a set of nodes of the plurality of nodes,
a link name to a link of the traversal links, and
a common link-display characteristic to a set of links of the traversal links.

19. The system of claim 18, wherein
the mapping further corresponds to at least one of:
a node-set name to the set of nodes, and
a link-set name to the set of links.

20. The system of claim 18, wherein
the common node-display characteristic includes at least one of: a name, a color, a font, a shape, a visibility parameter, and a style parameter.

21. The system of claim 18, wherein
the common link-display characteristic includes at least one of: a name, a color, a font, a shape, a visibility parameter, and a style parameter.

22. The system of claim 18, further including
a display processing system, operably coupled to the path analysis tool and the user interface, that is configured to display the graph based on the mapping.

23. The system of claim 22, wherein
the display processing system is further configured to:
consolidate information from the path analysis tool regarding nodes within the set of nodes to provide composite information related to the set of nodes, and
display the graph based further on the composite information.

24. The system of claim 18, wherein
the user interface is further configured to store the mapping for subsequent retrieval and reuse.

25. A method of presenting path analysis information, comprising:
providing a graph of a plurality of nodes and traversal links associated with each node of the plurality of nodes,
receiving user input to define a mapping corresponding to at least one of:
a node name to a node of the plurality of nodes,
a common node-display characteristic to a set of nodes of the plurality of nodes,
a link name to a link of the traversal links, and
a common link-display characteristic to a set of links of the traversal links, and
displaying the graph of the plurality of nodes and traversal links based on the mapping.

26. The method of claim 25, wherein
the mapping further corresponds to at least one of:
a node-set name to the set of nodes, and
a link-set name to the set of links.

27. The method of claim 25, wherein
the common node-display characteristic includes at least one of: a name, a color, a font, a shape, a visibility parameter, and a style parameter.

28. The method of claim 25, wherein
the common link-display characteristic includes at least one of: a name, a color, a font, a shape, a visibility parameter, and a style parameter.

29. The method of claim 25, wherein
displaying the graph includes:
consolidating information regarding nodes within the set of nodes to provide composite information related to the set of nodes, and
displaying the graph based further on the composite information.

30. The method of claim 25, further including
storing the mapping for subsequent retrieval and reuse.

31. A method of providing an Internet Path-Analysis service, comprising:
providing access to a path analysis tool that is configured to record traversals to and from one or more user web-pages,
providing access to a user interface that is configured to receive an identification of a target from among the one or more user web-pages, and
providing access to a display processor that is configured to display traversals relative to the target, wherein
the traversals include at least one of:
incoming links that identify locations from which prior users arrived at the target, and
outgoing links that identify locations to which the prior users departed from the target.

32. The method of claim 31, further including:
allowing the user to subsequently select one of the identified locations as the select target, via the user interface, and
displaying traversals relative to the select one of the identified locations, via the display processor.

33. The method of claim 31, wherein
the select target includes a page of an Internet web site.

34. The method of claim 31, wherein
the display processor is configured to display the traversals relative to the select target as a directed graph.

35. The method of claim 34, wherein
links of the directed graph are displayed based on a frequency distribution associated with occurrences of the prior users arriving at and departing from the select target.

36. The method of claim 31, further including
providing access to a database that contains a frequency distribution associated with occurrences of the prior users arriving at and departing from the select target, via the incoming and outgoing links, and
wherein
the display processor is further configured to display the traversals relative to the select target based on the frequency distribution.

37. A method of providing an Internet Path-Analysis service, comprising:
providing access to a path analysis tool that is configured to record traversals to and from one or more user web-pages,
providing access to a display processor that is configured to display a graph of a plurality of nodes associated with each node of the one or more user-pages and traversal links associated with the traversals to and from the one or more user web-pages, and
providing access to a user interface, operably coupled to the path analysis tool, that is configured to allow a user to define a mapping corresponding to at least one of:
a node name to a node of the plurality of nodes,
a common node-display characteristic to a set of nodes of the plurality of nodes,
a link name to a link of the traversal links, and
a common link-display characteristic to a set of links of the traversal links,
wherein
the display processor is configured to display the graph based on the mapping.

38. The method of claim 37, wherein
the mapping further corresponds to at least one of:
a node-set name to the set of nodes, and
a link-set name to the set of links.

39. The method of claim 37, wherein
the common node-display characteristic includes at least one of: a name, a color, a font, a shape, a visibility parameter, and a style parameter.

40. The method of claim 37, wherein
the common link-display characteristic includes at least one of: a name, a color, a font, a shape, a visibility parameter, and a style parameter.

41. The method of claim 37, wherein
the display processor is further configured to:
consolidate information regarding nodes within the set of nodes to provide composite information related to the set of nodes, and
display the graph based further on the composite information.

42. The method of claim 37, further including
storing the mapping for subsequent retrieval and reuse.
